(19) United States
(12) Patent Application Publication
(10) Pub. No.: US 2005/0091774 A1
(43) Pub. Date: May 5, 2005

(54) Mop handle connector

(76) Inventor: Blyth S. Biggs, (US)

Correspondence Address: Herbert C. Schulze, 2790 Wrondel Way, PMB36, Reno, NV, 89502, US

(21) Appl. No.: 10/702,128

(22) Filed: Nov. 5, 2003

(51) Int. Cl. B25G 3/00

(52) U.S. Cl. 15/145

(57) ABSTRACT

This is a mop head to mop handle connector which is configured to avoid slippage between the connector and the mop head by placing ridges on the connector where it ontacts the mop head in order to prevent a film of water of the like from providing a slippery connection by placing ridges on the connector which prevent flat contact of the mop head with the connector.

### CROSS REFERENCE TO RELATED PATENT APPLICATIONS

This Application is not related to any pending application filed by me.

### BACKGROUND OF THE INVENTION

I. Field of the Invention

This invention is in the general field of mops used in janitorial services;

The invention is more particularly in the field of mop head to handle connectors.

II. Description of the Prior Art

There have been many connectors for mop heads to handles. There have been connectors which appear at first glance to be identical to my present invention.

However, I have been unable to find, and am unaware of any connector which suggest or anticipate my present invention which is strictly directed to a system for preventing unwanted unscrewing of the mop head from the connector.

### SUMMARY OF THE INVENTION

I have been interested in mops and mopping for some time. A very widely used device for connecting mop heads to handles is a connector which consists of a socket adapted to attach to a mop handle with a threaded boss suitable to be attached to a mop head. These are in wide use, but have one major disadvantage. That disadvantage is that the threaded connection between the connector and the mop head frequently comes loose, no matter how tightly they are screwed together. This causes inconvenience and loss of time.

I have now conceived and developed a very simple connector of this nature which eliminates the problem. I have done this with a novel, unique, and useful series of small protruding, radial aligned ridges on a shoulder of the threaded boss which grip the mop head in a manner which prevents unwanted loosening of the mop head on the threaded boss but does not interfere with proper removal when desired.

It is an object of this invention to provide an improved mop head handle connector which will not loosen its grip upon a mop head under ordinary use of the device for mopping;

Another object of this invention is to provide such a connector which is easy to attach to and detach from a mop head.

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a partially broken away schematic perspective view of a mop head to handle connector embodying the features of my new invention;

FIG. 2 is a partially broken away schematic perspective of the mop head connecting socket; and

FIG. 3 is a section on 3—3 on FIG. 1.

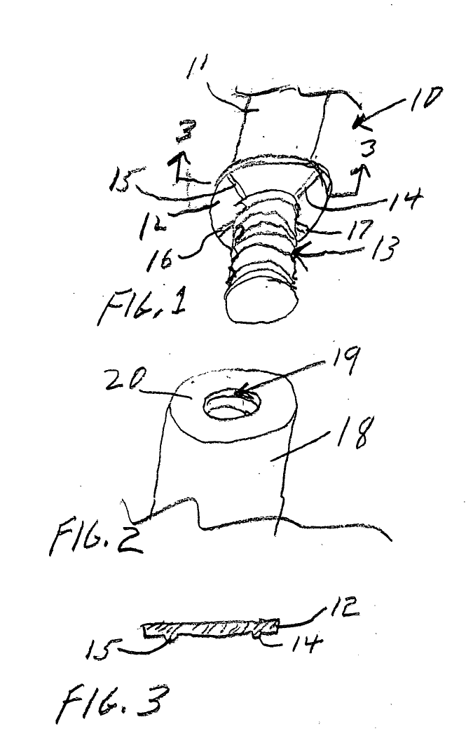

### DESCRIPTION OF A PREFERRED EMBODIMENT

An inventory of items in the drawings with reference numerals is:

Numeral Item

10 Connector
11 Handle socket
12 Flange
13 Threaded shank
14 Ridge
15 Ridge
16 Ridge
17 Ridge
18 Mop head boss
19 Threaded socket
20 Shoulder

The figs. should be viewed together.

A mop head/handle connecter 10 with the handle socket 11 partially broken away is shown. A flange 12 is formed at the mop end of the connecter with ridges 14, 15, 16, and 17 radiating outwardly from the threaded shank 13. In use the threaded shank 13 will be scresed into threaded socket 19 in mop head boss 18 until the shoulder 20 abuts against the ridges 14, 15, 16, and 17 on flange 12.

Prior to my invention the shoulder 20 would have abutted flat against flange 12. Under that prior condition, there was frequently some water on the flange and shoulder since this arrangement was used during mopping. The water film created a condition where there was a hydroplaning effect between the shoulder and the flange resulting in frequent loosening of the connection between the mope head and the handle. This caused much loss of time for one doing mopping.

By this reference I incorporate the claims and abstract which follow in this description of a preferred embodiment the same as though they were fully set forth again here.

In the claims which follow if I fail to claim a patentable feature which is revealed in this application, such failure to claim be due to inadvertence and does not indicate any desire to abandon or dedicate such feature. In such event, upon discovering my omission I shall seek to correct it by reissue, continuing application, or other appropriate means.

While the embodiment of this invention shown and described is fully capable of achieving the objects and advantages desired, it is to be understood that such embodiment is shown for purposes of illustration only and not for purposes of limitation.

1. A method for preventing slippage between a mop head and a mop handle connector comprising: forming at least one elongate ridge on the connector in such manner that when the connector and the mop head are connected there is contact between the ridge and the mop head.

2. The method of claim 1 wherein the ridge is radial with relation to the connector.

3. The method of claim 1 wherein there are a multiplicity of ridges on the connector.

4. A mop handle connector comprising: means to accept a mop handle; flange means suitable to be connected to a mop head carried by said means to accept a mop handle; and at least one elongate ridge means suitable to contact a mop head on said flange means.

5. The mop handle connector of claim 4 wherein there are a multiplicity of ridge means.
